(19) United States
(12) Patent Application Publication
(10) Pub. No.: US 2010/0017369 A1
(43) Pub. Date: Jan. 21, 2010

(54) DATABASE SYSTEM AND ITS HANDLING METHOD FOR IDEOGRAM

(76) Inventor: In Ki Park, Busan (KR)

Correspondence Address: CHRISTOPHER PAUL MITCHELL, 888 16TH ST., NW, SUITE 800, WASHINGTON, DC, 20006, US

(21) Appl. No.: 12/442,706

(22) PCT Filed: Sep. 27, 2007
(86) PCT No.: PCT/KR2007/004696

§ 371 Date: Sep. 4, 2009

(30) Foreign Application Priority Data
Sep. 29, 2006 (KR) 10-2006-0095353

(51) Int. Cl. G06F 17/30

(52) U.S. Cl. 707/3; 707/E17.014; 707/E17.031

(57) ABSTRACT

The present invention relates to a database system for ideograms and a processing method thereof. The database system includes an ideogram database having fields in which shapes of characters constituting the ideograms are separated into Chinese radicals comprised of dots and strokes, each Chinese radical comprising one stroke count, a sequence is assigned to each of the Chinese radicals, and the respective ideograms are arranged according to the sequences of the Chinese radicals and a stroke order of each ideogram; and a list window for searching the ideogram database for the ideograms based on the arranged sequences of the ideograms. The database processing method includes the steps of providing an ideogram database having fields in which shapes of characters constituting the ideograms are separated into Chinese radicals comprised of dots and strokes, each Chinese radical being consisting of one stroke count, a sequence is assigned to each of the Chinese radicals, and the respective ideograms are arranged according to the sequences of the Chinese radicals and a stroke order of each ideogram, and providing a list window for searching the ideogram database for the ideograms based on the arranged sequences of the ideograms.

### TECHNICAL FIELD

The present invention relates to a database system for ideograms and a processing method thereof, and more particularly, to a database system for efficiently processing a database including ideogram, such as Chinese characters, and a processing method thereof.

### BACKGROUND ART

In general, a character is largely classified into pictogram, ideogram and phonogram depending on its type. The pictogram refers to characters for expressing the contents of a language all together. The ideogram refers to characters for expressing the meaning of a word as a symbol of a symbolic method like Chinese characters. The phonogram refers to characters for expressing elements or sound of a word as an abstract symbol like alphabets or the Korean alphabet.

Characters on the earth can be generally classified into three kinds of characters. The pictogram is generally used in pictorial symbols such as a signpost and can be substantially classified into the phonogram and the ideogram.

The phonogram may be divided into a syllable character in which one letter represents one syllable, and a phone character in which one letter represents one phone. The Korean alphabet has the property of a syllable character since it represents a syllable as the sum of a consonant and a vowel, but is more like the property of the phone character since the character can be dismantled and restored to the phone.

This phonogram represents a language by separating a syllable and has a limited number of separated syllables. Although a database is constructed using this phonogram, it is very scientific and efficient because indexing or search can be performed depending on the number and classification of a syllable.

However, the ideogram, such as Chinese characters, has a huge number of characters and is complicated in its input, and therefore has lots of problems in applying the digital era.

In Republic of Korea, in the case of Chinese characters, the standard Chinese characters 1800 has been designated and used for computation, etc. In China, according to the national standard (GB, Guo-Biao), the simplified Chinese characters 7445 in the case of GB2312, the simplified Chinese characters 7237, which are rarely used, in the case of GB7589, and 27484 letters in the case of GB 18030 have been designated. Further, in the case of Unicode, that is, the international standard, code values are assigned to characters and special symbols of 26 languages, which are being used all over the world, one by one in its character set ISO/IEC 10646-1. China copes with the international standard using its national standard GB and the compatible function of Unicode.

In Unicode, only 65,535 letters of initial 2 bytes were represented. However, it is classified into groups of each language and thus represented by 4 bytes. In Unicode 3.0 version, 57,709 letters are further represented.

In the case of Chinese characters, that is, a representative ideogram, only 1.3 hundred thousand characters or more are now known, but an exact number of the characters could not be known. Further, in Republic of Korea, China, Taiwan, and Japan where all or part of the Chinese characters are used, they use their own Chinese characters independently. Accordingly, there was a problem in that all the Chinese characters are standardized and processed.

Furthermore, even though there exists a system in which all the Chinese characters can be databased and input, such as computers or mobile phones, it is not an easy task to find and input desired Chinese characters of the 1.3 hundred thousand Chinese characters.

In most methods for inputting the Chinese characters that have been released so far, the Chinese characters are input according to radicals, a total of strokes or pronunciation. Chinese characters corresponding to each stroke count/total strokes/pronunciation are also in countless numbers. There were problems in that the Chinese characters can be input only when a stroke count/total strokes/pronunciation are known and a Chinese character to be input, of the list of Chinese character corresponding to each stroke count/total strokes/pronunciation, must be selected and input.

In case where Chinese characters of Unicode, which are arranged in order of a stroke count and total strokes of a Chinese character as shown in FIG. 1, are input, it is not an easy thing to find and input a letter of numerous letters. The list window of FIG. 1 is used to input expansion Chinese characters in A-rea Hanguel, which is one of the Korean alphabet word processors.

As another input method of the Chinese characters, there is a method of separating Chinese radicals and inputting the Chinese character according to the stroke order of the Chinese radicals. However, to search corresponding Chinese characters according to the order of each of the Chinese radicals in a Chinese character, present them to the list window and select them is the same as the input method according to the stroke count/total strokes/pronunciation, but Chinese characters shown on the list window are also arranged according to the sequence of a stroke count or a total stroke. Therefore, there was a problem in that it is difficult to find a Chinese character to be input.

The present applicant disclosed an epoch-making input method of classifying Chinese characters according to Chinese radicals and simply inputting the Chinese characters according to its stroke order through Korean Patent Application Nos. 10-2005-27139 and 10-2005-35576.

In accordance with the invention of the applicant, since the method of recognizing Chinese characters according to Chinese radicals and the sequence is used, any Chinese character can be input easily like phonogram if the sequence of the Chinese radicals is stored.

However, the invention of the present applicant corresponds to the input method only, but did not present a concrete method for computation and processing by applying it to a database including Chinese characters.

### DISCLOSURE OF INVENTION

### Technical Problem

Accordingly, the present invention has been made in view of the above problems occurring in the prior art, and an object of the present invention is to provide a database system in which ideogram, such as Chinese characters, can be processed efficiently and a processing method thereof.

### Technical Solution

To achieve the above object, a database system of the present invention includes an ideogram database having fields in which shapes of characters constituting the ideograms are separated into Chinese radicals comprised of dots and strokes, each Chinese radical comprising one stroke count, a sequence is assigned to each of the Chinese radicals, and the respective ideograms are arranged according to the sequences of the Chinese radicals and a stroke order of each ideogram; and a list window for searching the ideogram database for the ideograms based on the arranged sequences of the ideograms.

The database system further includes a user database including fields having values comprised of the ideograms contained in the ideogram database. The user database is arranged or searched according to the arranged sequences of the ideograms of the ideogram database.

In the list window, in the list window, the ideograms of the ideogram database are divided into predetermined numbers in order to form groups. If a list window of a first ideogram of each of the divided groups is generated and the first ideogram of each group is selected, the list window of an ideogram belonging to each group is displayed in the list window.

In the ideogram database, one or more of information, including a stroke count, pronunciation, and total strokes of the ideograms, are specified as the fields.

In the ideogram database, a character code or serial number individually assigned to each ideogram is specified as the field.

The Chinese radicals have the shapes of

[symbol]

, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
,
and [symbol]
and the arranged sequence.

In the arranged sequences of the ideograms of the ideogram database, characters in which [symbol] and [symbol] are located on left sides of the characters, such as [symbol] [symbol] and [symbol] and characters in which

[symbol]

is located on upper sides of the characters, such as

[symbol]

are arranged separated.

A database processing method for ideograms of the present invention includes a first step of providing an ideogram database having fields in which shapes of characters constituting the ideograms are separated into Chinese radicals comprised of dots and strokes, each Chinese radical comprising one stroke count, a sequence is assigned to each of the Chinese radicals, and the respective ideograms are arranged according to the sequences of the Chinese radicals and a stroke order of each ideogram, and a second step of providing a list window for searching the ideogram database for the ideograms based on the arranged sequences of the ideograms.

The database processing method further includes a third step of providing a user database including fields having values comprised of the ideograms contained in the ideogram database, and a fourth step of arranged or searching the user database according to the arranged sequences of the ideograms of the ideogram database.

In accordance with the present invention, not only the simplified Chinese characters, the traditional Chinese characters, and the variant forms of Chinese characters, but also Chu-nom characters (refer to FIG. 5), which correspond to variant Chinese characters that were uniquely changed while Chinese characters were propagated to other nations and used in Vietnam, Naxi characters, Jurchen characters, Khitan characters, Nushu characters (refer to FIG. 6), and Tangut characters (refer to FIG. 7), which are used in minority races within China can be represented.

Furthermore, in accordance with the present invention, Katakana, that is, characters derived from regular script (Standard script) of Japanese language can also be include din an ideogram database.

Furthermore, the present invention can be used irrespective of chirograhpy since Chinese radicals used in Chia-ku-wen, Chinewn, Chuanshu, seal script (Small seal), clerical script (Official script), regular script (Standard script), semi-cursive script (Running script), and cursive script (Grass script) are separated, and then their sequences are arranged.

Furthermore, the present invention can include part or all of Chinese characters used in Korea, China, Japan, and so on.

### ADVANTAGEOUS EFFECTS

If the database system for ideograms and the method according to the present invention are employed, Chinese characters can be input simply, and other databases including ideograms can be processed simply and efficiently.

### BRIEF DESCRIPTION OF THE DRAWINGS

Further objects and advantages of the invention can be more fully understood from the following detailed description taken in conjunction with the accompanying drawings in which:

FIG. 1 is a view illustrating a conventional Unicode Chinese character input window;

FIG. 2 is a view illustrating a list window of the present invention;

FIG. 3 is a view illustrating a list window related by the list window of FIG. 2;

FIG. 4 is a view illustrating another form the list window of FIG. 2;

FIG. 5 is a view illustrating an example of Chu-nom characters;

FIG. 6 is a view illustrating an example of NuShu characters; and

FIG. 7 is a view illustrating an example of Tangut characters.

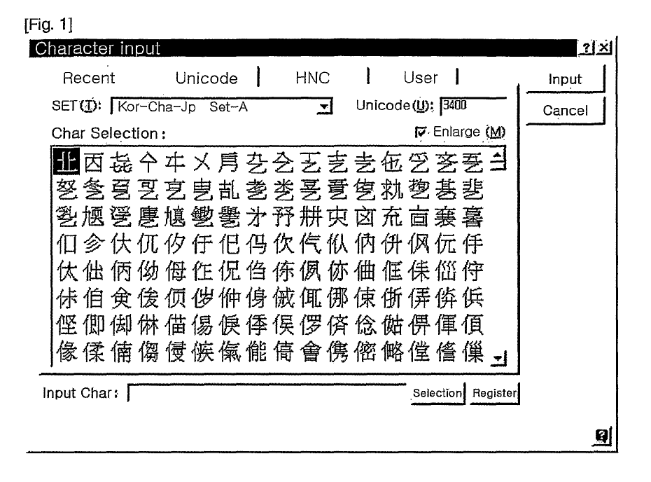

### MODE FOR THE INVENTION

The present invention will now be described in detail in connection with specific embodiments with reference to the accompanying drawings. In the following description, what the simplified Chinese characters are represented as regular script (Standard script) is a subject. However, those having ordinary skill in the art can also easily apply the technical spirit of the present invention to other forms of ideograms not the simplified Chinese characters.

First, in order to implement the present invention, Chinese radicals of the simplified Chinese character were separated and their sequences were assigned to the separated Chinese radicals.

In an embodiment, as described above, the Chinese radicals of the simplified Chinese character were classified into a total of 28 radicals:

[symbol]

, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
,

[symbol]

What the separated Chinese radicals correspond to what Chinese radicals constituting which Chinese character is described below.

(1)

[symbol]

(A): Chinese characters that begin with this Chinese radical include, for example, [symbol] [symbol] and so on.

(2)

[symbol]

(B1): Chinese characters that begin with this Chinese radical include, for example, [symbol] and [symbol] and a third Chinese radical of [symbol] uses this Chinese radical and a second radical of [symbol] also uses this Chinese radical.

(3)

[symbol]

(B2): A third Chinese radical of [symbol] uses this Chinese radical and a third Chinese radical of [symbol] also uses this Chinese radical.

(4)

[symbol]

(C): Chinese characters that begin with this Chinese radical include, for example, [symbol] [symbol] and so on.

(5)

[symbol]

(D): a fifth Chinese radical of [symbol] uses this Chinese radical and a fourth Chinese radical of [symbol] uses this Chinese radical.

(6)

[symbol]

(E): Chinese characters that begin with this Chinese radical include, for example, [symbol]
and so on, and a fifth Chinese radical of [symbol] uses this Chinese radical.

(7)

[symbol]

(F): Chinese characters using this Chinese radical are second Chinese radicals of

[symbol]

and

[symbol]

including the simplified Chinese character of

[symbol]

(8)

[symbol]

(G): Chinese characters that begin with this Chinese radical include, for example, [symbol] [symbol] and so on.

(9)

[symbol]

(H): Chinese characters that begin with this Chinese radical include, for example, [symbol] and a third Chinese radical of [symbol] also uses this Chinese radical.

(10)

[symbol]

(I1): Chinese characters that begin with this Chinese radical include, for example, [symbol] and [symbol] and a fifth Chinese radical of

[symbol]

uses this Chinese radical.

(11)

[symbol]

(I2): Chinese characters that begin with this Chinese radical include, for example, [symbol] [symbol] and so on.

(12)

[symbol]

(J): Chinese characters that begin with this Chinese radical include, for example

[symbol]

[symbol]

and so on.

(13)

[symbol]

(K): Chinese characters that begin with this Chinese radical include, for example, [symbol] [symbol] and so on.

(14)

[symbol]

(L): Chinese characters that begin with this Chinese radical include, for example,

[symbol]

[symbol]

and so on.

(15)

[symbol]

(M): A second Chinese radical of

[symbol]

uses this Chinese radical and a fifth Chinese radical of [symbol] uses this Chinese radical.

(16)

[symbol]

(N): A second Chinese radical of

[symbol]

uses this Chinese radical and a fourth Chinese radical of

[symbol]

uses this Chinese radical.

(17)

[symbol]

(O): Chinese characters that begin with this Chinese radical include, for example, [symbol] [symbol] and so on.

(18)

[symbol]

(P): A third Chinese radical of [symbol] uses this Chinese radical and second Chinese radicals of [symbol] etc. use this Chinese radical.

(19)

[symbol]

(Q): Chinese characters that begin with this Chinese radical include, for example,

[symbol]

and a fourth Chinese radical of [symbol] uses this Chinese radical.

(20)

[symbol]

(R): Chinese characters that begin with this Chinese radical include, for example,

[symbol]

[symbol]

[symbol]

and so on.

(21)

[symbol]

(S): Chinese characters that begin with this Chinese radical include, for example, [symbol] [symbol] and so on.

(22)

[symbol]

(T): Chinese characters that begin with this Chinese radical include, for example,

[symbol]

and a second Chinese radical of [symbol] and a sixth Chinese radical of [symbol] use this Chinese radical.

(23)

[symbol]

(U): Chinese characters that begin with this Chinese radical include, for example, [symbol] [symbol] and so on.

(24)

[symbol]

(V): Chinese characters that begin with this Chinese radical include, for example, [symbol] [symbol] and so on.

(25)

[symbol]

(W): A second Chinese radical of [symbol] uses this Chinese radical and a second Chinese radical of [symbol] uses this Chinese radical.

(26)

[symbol]

(X): A fourth Chinese radical of [symbol] uses this Chinese radical and a fifth Chinese radical of [symbol] uses this Chinese radical.

(27)

[symbol]

(Y): Chinese characters that begin with this Chinese radical include, for example,

[symbol]

[symbol]

and so on.

(28)

[symbol]

(Z): Chinese characters that begin with this Chinese radical include, for example, [symbol] [symbol] and so on.

As in the description of each Chinese radical, the number of strokes that could not be used as a first stroke in the simplified Chinese character is eight; (3)^{th}, (5)^{th}, (7)^{th}, (15)^{th}, (16)^{th}, (18)^{th}, (25)^{th} and (26)^{th} strokes of the above numbers.

When 7 thousands Chinese characters (

[symbol]

[symbol]

7000 [symbol]
designated by Chinese Government) are arranged according to the sequences of the separated Chinese radicals in line with the stroke order, they are arranged in order of

[symbol]

[symbol]

. . . (skip) . . .

[symbol]

[symbol]

As in the description of each Chinese radical, if alphabets are made to correspond to numbers, codes can be assigned to respective characters. For example, [symbol] can be represented by AA, [symbol] can be represented by AKA, and [symbol] can be represented by AAK according to respective Chinese radicals and stroke orders.

[symbol] and [symbol] can be represented by AKA in the same manner as [symbol] In this case, for example, a code AKA1 may be assigned to [symbol] a code AKA2 may be assigned to [symbol] and a code AKA3 may be assigned to

[symbol]

For example, a case where a character is constituted by one Chinese radical like [symbol] and [symbol] is very rare. If characters are input according to the above Chinese radicals and stroke orders, characters to be input to the select window must be selected and input. In other words, if AKA is input, a list of characters that begin with AKA, such as [symbol] [symbol] and [symbol] is displayed on the list window. If [symbol] that is, one of them is selected, [symbol] is input and AKA1, that is, the code corresponding to the character is assigned to

[symbol]

Instead of this code, characters may be classified by assigning serial numbers to the characters according to the sequence of each character.

Assuming that a name, an address, and a telephone number are constituted by respective fields as in an address book or a telephone directory and there is a user database in which names and the addresses are input as ideograms, if the names or the addresses are arranged or searched according to arranged sequence and codes (or serial numbers) of the ideogram database, data of the user database can be processed very efficiently. The user database may include any kinds of things such as various Chinese character dictionaries (lexicons) or various documents. If there exist fields comprised of ideograms, data can be processed efficiently in association with the ideogram database. In other words, since an ideogram having a form has a sequence like alphabets, data can be processed very efficiently.

The ideogram database can also be used to input ideograms very usefully.

In case where Chinese characters to be input are selected according to the arranged method of ideograms of the present invention, the simplified Chinese characters of 7000 characters

[symbol]

[symbol]

[symbol]

can be input through twice clicks of the mouse and up to million characters can be easily input through up to three clicks of the mouse.

This is described in detail by taking an example of inputting

[symbol]

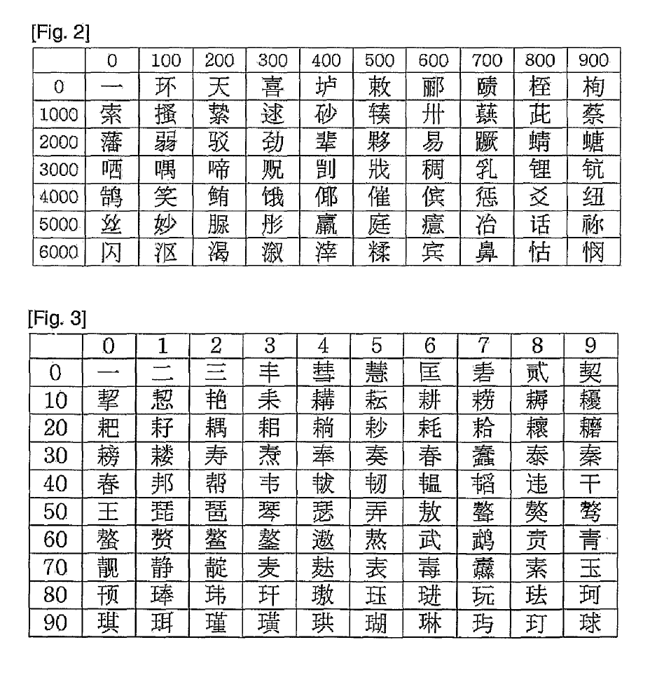

In the ideogram database, ideograms are divided into a previously designated number and form groups. A first ideogram of each of the divided groups is indicated in the list window. FIG. 2 shows that 7000 simplified Chinese characters are divided every 100 and form groups, and a first ideogram of each of the divided groups is processed. That is, a number 0 is assigned to [symbol] a number 100 is assigned to

[symbol]

. . . a number 6900 is assigned to

[symbol]

[symbol] has the stroke order of [symbol] (A), [symbol] (A),

[symbol]

### (K), (A),

[symbol] (S), . . . , and is precedent to the stroke order of [symbol] (A), [symbol] (A),

[symbol]

### (K),

[symbol]

### (B1), . . . , of

[symbol] which is assigned with the number 100. Thus, it can be seen that [symbol] exists between the number 0 to the number 99. In other words, this is because when arranged them according to an alphabet sequence, AAKAS . . . are precedent to AAKB1 . . . .

If a user selects [symbol] using the mouse, the list window from 0 to 99 appears as shown in FIG. 3. Ideograms displayed on the list window are also arranged according to their Chinese radicals and sequences of the present invention and, therefore, [symbol] having a number 75 can be selected easily.

If ideograms are input using the ideogram database according to the above method, desired characters of ideograms of 7000 characters can be selected and input through only twice mouse clicks.

If this method used, even one million ideograms can be input through only three mouse clicks by forming each list window as 10×10 over three steps.

It has been described above that the mouse is used to specify characters in the list window. However, characters that will be input can also be selected while inputting numbers listed in the list window using the keyboard. For example, if 0 is input while viewing the list window as shown in FIG. 2, the list window as shown in FIG. 3 is generated. If 75 is input in the list window of FIG. 3, [symbol] can be input.

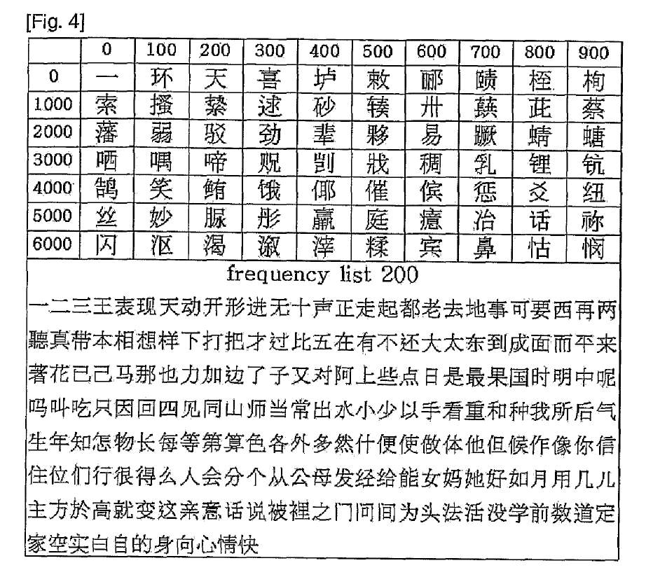

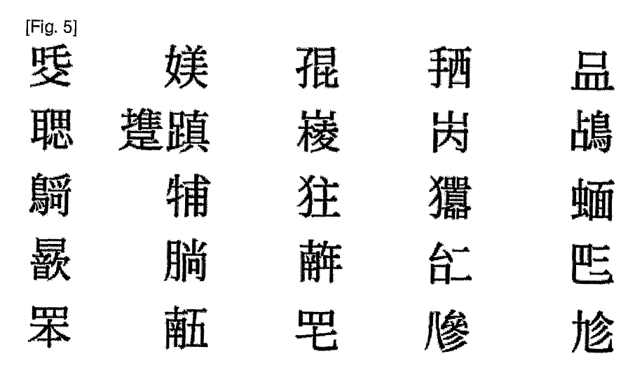

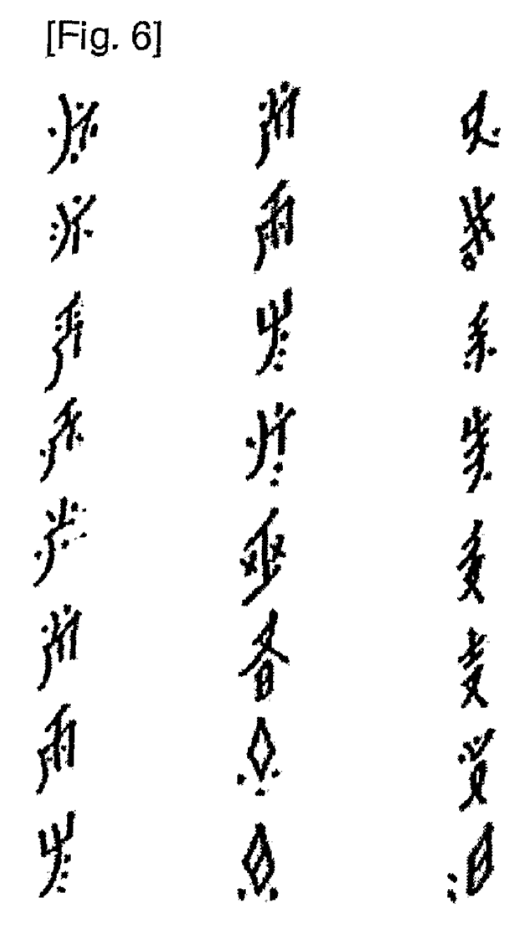

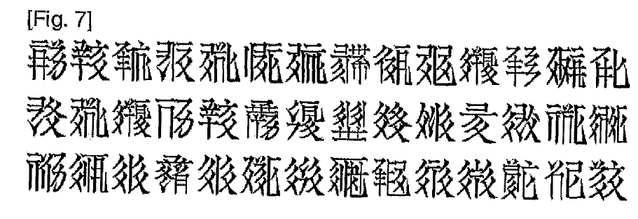

Furthermore, the list window as shown in FIG. 2 can also be provided along with a frequency window in which Chinese characters that are frequently input are collected at its bottom as shown in FIG. 4.

Further, the ideogram database may have a structure as shown in the following Table 1.

TABLE 1
Example of ideogram database structure

| Serial | Serial | | | | |
|---|---|---|---|---|---|
| number | number | | | | Total |
| 1 | 2(code) | Ideogram | Stroke count | Pronunciation | strokes |
| 0 | A | [symbol] | [symbol] | Y1 | 1 |
| 1 | AA | [symbol] | [symbol] | ER | 2 |
| 2 | AAA | [symbol] | [symbol] | SAN | 3 |
| 3 | AAAK | [symbol] | [symbol] | FENG | 4 |
| . . . | . . . | . . . | . . . | . . . | . . . |

If the ideogram database has the above structure, a user who is accustomed to input characters according to a stroke count/total strokes/pronunciation, etc. can also use the ideogram database structure. One or more of the stroke count/total strokes/pronunciation can also be selectively included in the ideogram database structure. Furthermore, in pronunciation, Pinyins of the simplified Chinese characters are listed in pronunciation in Table 1. However, since pronunciation corresponding to Chinese characters may vary every country, the database can be constructed according to each countrys pronunciation. Of course, all pronunciation of Korea, China and Japan can be included.

### INDUSTRIAL APPLICABILITY

If the database system for ideograms and the method according to the present invention are employed, Chinese characters can be input simply, and other databases including ideograms can be processed simply and efficiently.

Although the specific embodiments of the present invention have been disclosed for illustrative purposes, those skilled in the art will appreciate that various modifications, additions and substitutions are possible, without departing from the scope and spirit of the invention as disclosed in the accompanying claims.

1. A database system for ideograms, comprising:
an ideogram database having fields in which shapes of characters constituting the ideograms are separated into Chinese radicals comprised of dots and strokes,
each Chinese radical comprising one stroke count, a sequence is assigned to each of the Chinese radicals, and the respective ideograms are arranged according to the sequences of the Chinese radicals and a stroke order of each ideogram; and
a list window for searching the ideogram database for the ideograms based on the arranged sequences of the ideograms.

2. The database system of claim 1, further comprising:
a user database including fields having values comprised of the ideograms contained in the ideogram database,
wherein the user database is arranged or searched according to the arranged sequences of the ideograms of the ideogram database.

3. The database system of claim 1, wherein in the list window, the ideograms of the ideogram database are divided into predetermined numbers in order to form groups, and
if a list window of a first ideogram of each of the divided groups is generated and the first ideogram of each group is selected, the list window of an ideogram belonging to each group is displayed in the list window.

4. The database system of claim 1, wherein in the ideogram database, one or more of information, including a stroke count, pronunciation, and total strokes of the ideograms, are specified as the fields.

5. The database system of claim 1, wherein in the ideogram database, a character code or serial number individually assigned to each ideogram is specified as the field.

6. The database system of claim 1, wherein the Chinese radicals have the shapes of [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
, [symbol]
,
and [symbol]
and the arranged sequence.

7. The database system of claim 1, wherein in the arranged sequences of the ideograms of the ideogram database, characters in which [symbol] and [symbol] are located on left sides of the characters, such as [symbol] and [symbol] and characters in which [symbol]
is located on upper sides of the characters, such as [symbol]
are arranged separated.

8. A database processing method for ideograms, comprising:
a first step of providing an ideogram database having fields in which shapes of characters constituting the ideograms are separated into Chinese radicals comprised of dots and strokes, each Chinese radical comprising one stroke count, a sequence is assigned to each of the Chinese radicals, and the respective ideograms are arranged according to the sequences of the Chinese radicals and a stroke order of each ideogram; and
a second step of providing a list window for searching the ideogram database for the ideograms based on the arranged sequences of the ideograms.

9. The database processing method of claim 8, further comprising:
a third step of providing a user database including fields having values comprised of the ideograms contained in the ideogram database, and
a fourth step of arranged or searching the user database according to the arranged sequences of the ideograms of the ideogram database.
